(19) United States
(12) Patent Application Publication
(10) Pub. No.: US 2007/0074773 A1
(43) Pub. Date: Apr. 5, 2007

(54) Fluidic device

(75) Inventors: Fumiko Shiraishi, Minami-Ashigara-shi (JP); Yasunori Ichikawa, Minami-Ashigara-shi (JP); Norihito Nosaka, Minami-Ashigara-shi (JP); Hideharu Nagasawa, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/540,520

(22) Filed: Oct. 2, 2006

(30) Foreign Application Priority Data
Sep. 30, 2005 (JP) 2005-288791

(51) Int. Cl. F15C 1/04

(52) U.S. Cl. 137/828

(57) ABSTRACT

A fluidic device, comprising: a temperature regulating mechanism for regulating a temperature of a plurality of fluids in a reaction operation or a unit operation while the fluids are distributed in a fluid flow path, wherein the temperature regulating mechanism includes a heating medium flow path formed therein along a flow direction of the fluids in the fluid flow path in which a heating medium at a desired temperature flows and a disturbance producing device for producing turbulence in a laminar flow of the heating medium.

### BACKGROUND OF THE INVENTION

1. Field of the Invention

The present invention relates to a fluidic device, in particular, a fluidic device which is provided with a temperature regulating mechanism for regulating a temperature of a fluid flowing in a fluid flow path of a micro flow path width.

2. Description of the Related Art

Conventionally, in the fields of chemical processes for manufacturing medicines, reagents and the like or chemical substances such as fine magnetic particles, an agitation tank equipped with coils or jackets for controlling temperature is used as a reaction apparatus having a temperature regulating mechanism.

However, a current trend requires chemical substances which have a greater degree of purity and a higher quality to be manufactured, and the time has come that such a request goes beyond the ability of macro production apparatuses having a large volume like the agitation tank.

In the context described above, in recent years in the fields of chemical processes, fluidic devices which are generally called as micro mixer, micro reactor, or the like draw attentions. A fluidic device performs reaction operations or unit operations, or processes such as mixing, separation, extraction, or the like, by distributing a plurality of fluids through a fluid flow path having a narrow cross section area for continuously producing chemical substances. For example, in such a fluidic device a reaction occurs, unlike in the case of batch systems for reactions using agitating tanks, at interfaces of fluids where different kinds of reacting molecules in the fluids face each other while the fluids are continuously flowing through a fluid flow path which is narrow space, and so a reaction efficiency is extremely improved, and chemical substances having highly monodispersed fine particles can be manufactured, especially when the reaction products are fine particles. Typically, in such reaction operations or unit operations in a fluidic device, fluids which flow in a fluid flow path are controlled to have an appropriate temperature by a temperature regulating mechanism.

The small size of a fluidic device makes a temperature regulating mechanism itself inevitably have a micro size. A temperature regulating mechanism, which can be constructed in a micro size, electrically regulates a temperature of fluids through a fluid flow path by applying a voltage to metal pieces which are finely attached to the fluidic device, or has a jacket structure to regulate a temperature of fluids through a fluid flow path by flowing a heating medium through a heating medium flow path which is finely provided in the fluidic device. However, the temperature regulation by the application of voltage to metal pieces provides only heating of the fluidic device, and it cannot provide cooling of the fluidic device. A use of peltier elements metal may be possible to allow the cooling, but then the peltier elements cannot provide heating. In addition, there is a disadvantage in using peltier elements that the fluidic device is subject to the influences of exothermy which occurs at the same time of endothermy. Thus, in order to perform heating and cooling operations at the same time, at least two kinds of metals need to be attached, which results in a complicated and large sized device. So generally, in a device to which metal pieces are attached for temperature regulation, only one of the heating operation and the cooling operation can be performed. This limits reaction operations or unit operations to be performed in such a device to which metal pieces are attached for temperature regulation. Therefore, a temperature regulating mechanism usually has a jacket structure having a micro heating medium flow path (micro channel).

Such an apparatus for exchanging heat with fluids in a fluid flow path by using a heating medium flow path for a heating medium is for example disclosed in Japanese Patent Application Laid-Open No. 2005-83676 and Japanese Patent Application Laid-Open No. 2005-83674, the apparatus having a heating medium flow path which is provided under a flow path for distributing liquids to be regulated in temperature, in order to circulate a heating medium to regulate a temperature of the fluids. Another fluidic device is disclosed in Japanese Patent Application Laid-Open No. 2004-130219, which produces a large gradient of temperature of fluids in a fluid flow path. In the fluidic device, temperature regulating mechanisms are provided on a front and rear surfaces of the device to form a temperature distribution in the thickness direction of the device, and a horizontal flow path (a flow path parallel to the front and rear surfaces of the device) and a vertical flow path (a flow path between the front and rear surfaces of the device) are combined, so that fluids are subject to a large temperature gradient by way of the temperature distribution when the fluids flow in the vertical flow path.

If a temperature regulating mechanism having a jacket structure which is provided with a fine heating medium flow path is used in a fluidic device, because a heating medium forms a laminar flow in the heating medium flow path, a laminar film of the flow gets thicker than that in forming turbulence, and provides a lower rate of heat transfer. As a result, a temperature responsiveness of the fluid in a fluid flow path to follow a temperature change of the heating medium is reduced, and also there is formed a distribution of the rate of heat transfer at a central portion and both end portions (portions at wall surface of the flow path where the laminar film is formed) of the heating medium flow path in the width direction thereof, and the distribution in turn forms a temperature distribution in the fluid flow path to give an adverse effect on a uniformity in a reaction operation or unit operation to be performed.

However, in the technologies in Japanese Patent Application Laid Open Nos. 2005-83676 and 2005-83674, a fine heating medium flow path is modified to have a larger flow path cross sectional area to reduce a resistance in the flow path, and this does not dissolve the above problem of a low rate of heat transfer due to the laminar flow which is formed by a heating medium. In Japanese Patent Application Laid Open No 2004-130219, while fluids are passing through the vertical flow path part of the fluid flow path, the fluids have a gradual temperature gradient, and the temperature of the fluids do not rapidly change, for example in a stepped way.

The present invention was made in view of the above background, and one object of the present invention is to provide a fluidic device having a temperature regulating mechanism of a jacket structure with a heating medium flow path which improves a responsiveness to temperature control because a rate of heat transfer to a fluid in a fluid flow path can be increased in regulating a temperature of the fluid flow path.

### SUMMARY OF THE INVENTION

A first aspect according to the present invention, in order to achieve the above object, provides a fluidic device, comprising:

a temperature regulating mechanism for regulating a temperature of a plurality of fluids in a reaction operation or a unit operation while the fluids are distributed in a fluid flow path,

wherein the temperature regulating mechanism includes a heating medium flow path formed therein along a flow direction of the fluids in the fluid flow path in which a heating medium at a desired temperature flows and a disturbance producing device for producing turbulence in a laminar flow of the heating medium.

The term “disturbance producing device” as used herein means a device which produces turbulence to a heating medium flow by inputting energy or mixing particles having a different phase into the heating medium from outside of the heating medium.

According to the first aspect of the present invention, because the temperature regulating mechanism includes a heating medium flow path formed therein along a flow direction of the fluids in the fluid flow path in which a heating medium at a desired temperature flows, and a disturbance producing device for producing turbulence in a laminar flow of the heating medium, even when a laminar flow of the heating medium in the heating medium flow path forms a thick laminar film, the disturbance producing device breaks the laminar film and makes the film thinner. This improves a rate of heat transfer from the heating medium flow path to the fluid flow path. Thus, a fluidic device of the present invention improves a rate of heat transfer to a fluid in a fluid flow path, which in turn improves a responsiveness to temperature regulation. The term “fluid” as used herein includes any liquid, gas, solid-liquid two-phase fluid, gas-liquid two-phase fluid, and the like.

A second aspect of the present invention according to the first aspect provides the fluidic device, characterized in that the fluid flow path has a flow path width of 1 mm or less.

A fluidic device according to the present invention is configured as described in the second aspect, because the present invention is more effective when a heating medium flow path is required to be constructed as a micro flow path similar to a fluid flow path having a flow path width of 1 mm or less.

A third aspect of the present invention according to the first aspect or the second aspect provides the fluidic device, characterized in that the disturbance producing device is a plurality of heating medium supply tubes which make heating medium flowing into the heating medium flow path collide to each other.

According to the third aspect, because a plurality of heating medium supply tubes are provided to supply heating medium into a heating medium flow path and make the flows of the heating medium collide to each other, turbulence such as a vortex flow is produced in the heating medium flow. The vortex flow breaks a laminar film and makes the film thinner.

A fourth aspect of the present invention according to any one of the first to third aspects provides the fluidic device, characterized in that the disturbance producing device is a low frequency vibration applying device which generates low frequency vibrations in the heating medium.

According to the fourth aspect, because a low frequency vibration applying device is used as a disturbance producing device to generate low frequency vibrations in the heating medium, turbulence such as a vortex flow is produced in the heating medium flow. The vortex flow breaks a laminar film and makes the film thinner. This low frequency vibration applying device may be used with the plurality of heating medium supply tubes described above.

A fifth aspect of the present invention according to any one of the first to fourth aspects provides the fluidic device, characterized in that the disturbance producing device is fine particles to be mixed into the heating medium.

According to the fifth aspect, the fine particles mixed into the heating medium rub against a wall in the heating medium flow path so that a laminar film is broken. Also, collisions between the fine particles in the heating medium produce turbulence such as a vortex flow in the heating medium flow. The vortex flow also breaks a laminar film and makes the film thinner. These fine particles may be used with the plurality of heating medium supply tubes and the low frequency vibration applying device described above.

A sixth aspect of the present invention according to the fifth aspect provides the fluidic device, characterized in that the fine particles have a cross sectional area which is one tenth that of the heating medium flow path or less.

The cross sectional area which is one tenth that of the heating medium flow path or less of the fine particles to be mixed into the heating medium facilitates the fine particles to move freely and collide to each other in the heating medium flow path, and the collisions efficiently produce turbulence in the heating medium.

A seventh aspect of the present invention according to any one of the first to sixth aspects provides the fluidic device, characterized in that the disturbance producing device is air fine bubbles to be mixed into the heating medium.

According to the seventh aspect, the air fine bubbles mixed into the heating medium rub against a wall in the heating medium flow path so that a laminar film is broken. Also, the air fine bubbles in the heating medium produce turbulence such as a vortex flow in the heating medium flow. The vortex flow also breaks a laminar film and makes the film thinner. Unlike in the case of fine particles, because the air fine bubbles to be mixed into the heating medium do not have any effect to disturb a flow if they disappear, the air fine bubbles are preferably formed by blowing air into the heating medium just before the heating medium is supplied into the heating medium flow path. These air fine bubbles may be used with the plurality of heating medium supply tubes, the low frequency vibration applying device, and the fine particles described above.

An eighth aspect of the present invention according to the seventh aspect provides the fluidic device, characterized in that the air fine bubbles have a cross sectional area which is one tenth that of the heating medium flow path or less.

The air fine bubbles according to the present invention are designed as described in the eighth aspect because too large air fine bubbles tend to immediately rise to the upper surface of the heating medium flow path and pile there due to the buoyancy thereof, resulting in a reduced effect to produce turbulence in the heating medium flow.

A ninth aspect of the present invention according to any one of the first to eighth aspects provides the fluidic device, characterized by further comprising: a tabular fluid flow path plate having the fluid flow path formed therein for distributing the plurality of fluids; a tabular heating medium flow path plate which is mounted to an upper surface or lower surface of the fluid flow path plate and has the heating medium flow path formed therein; a fluid supplying device for supplying the plurality of fluids to the fluid flow path; and a heating medium supplying device for supplying a heating medium to the heating medium flow path.

The ninth aspect includes a fluidic device in which a plurality of fluids flow in the fluid flow path. According to the ninth aspect, a tabular heating medium flow path plate having the heating medium flow path formed therein is mounted to be fit with an upper surface or lower surface of a tabular fluid flow path plate having the fluid flow path formed therein for distributing the plurality of fluids. The plurality of fluids are supplied from a fluid supplying device to the fluid flow path for a reaction operation or unit operation, while a heating medium is supplied from a heating medium supplying device to the heating medium flow path for a temperature regulation of the fluids in the fluid flow path. This configuration allows a heat exchange between the heating medium in the heating medium flow path and the heating medium in the fluid flow path, resulting in that a temperature of the fluids is regulated. In such a fluidic device, a disturbance producing device produces turbulence in the heating medium which is flowing in the heating medium flow path. The fluid supplying device is preferably provided individually for each of the plurality of fluids.

A tenth aspect of the present invention according to any one of the first to eighth aspects provides the fluidic device, characterized by further comprising: a cylindrical fluid flow path block having the fluid flow path formed therein for distributing the plurality of fluids as a concentric flow; a cylindrical heating medium flow path block which is mounted outside of the fluid flow path block and has a heating medium flow path formed therein; a fluid supplying device for supplying the plurality of fluids to the fluid flow path; and a heating medium supplying device for supplying a heating medium to the heating medium flow path.

The tenth aspect includes a concentric flow type of fluidic device in which a plurality of fluids flow in a fluid flow path as a concentric flow. According to the tenth aspect, a cylindrical heating medium flow path block having a heating medium flow path formed therein is mounted to be fit with the outside of a cylindrical fluid flow path block having the fluid flow path formed therein for distributing the plurality of fluids as a concentric flow. The plurality of fluids are supplied from a fluid supplying device to the fluid flow path for a reaction operation or unit operation, while a heating medium is supplied from a heating medium supplying device to the heating medium flow path for a temperature regulation of the fluids in the fluid flow path. This configuration allows a heat exchange between the heating medium in the heating medium flow path and the heating medium in the fluid flow path, resulting in that a temperature of the fluids is regulated. In such a concentric flow type of fluidic device, a disturbance producing device produces turbulence in the heating medium which is flowing in the heating medium flow path. The fluid supplying device is preferably provided individually for each of the plurality of fluids.

As described above, according to a fluidic device of the present invention, a temperature regulation of a fluid flow path by a temperature regulating mechanism having a jacket structure with a heating medium flow path improves a rate of heat transfer to a fluid which is flowing in a fluid flow path, which in turn improves a responsiveness to temperature control.

### BRIEF DESCRIPTION OF THE DRAWINGS

FIG. 1 is a view illustrating an entire structure of a thin film flow type of fluidic device according to the present invention;

FIGS. 2A to 2C are views illustrating an inside structure of a device body of a thin film flow type of fluidic device;

FIG. 3 is a conceptual view showing a plurality of heating medium supply tubes as an aspect of a disturbance producing device;

FIG. 4 is a conceptual view showing a low frequency vibration applying device as another aspect of a disturbance producing device;

FIG. 5 is a conceptual view showing fine particles or air fine bubbles as another aspect of a disturbance producing device;

FIG. 6 is a cross sectional view showing a structure of a heating medium flow path in a thin film flow type of fluidic device;

FIGS. 7A and 7B are views illustrating a flow rate distribution in a heating medium flow path in a thin film flow type of fluidic device;

FIGS. 8A and 8B are views illustrating a flow rate distribution in a heating medium flow path in a conventional thin film flow type of fluidic device;

FIG. 9 is a view illustrating heating medium flow paths which are provided in a flow direction of fluids;

FIGS. 10A and 10B are views illustrating a heating medium flow path which has a tapered structure;

FIG. 11 is a cross sectional view showing a heating medium flow path which has a concave cross section;

FIG. 12 is a cross sectional view showing a heating medium flow path which has a divided portions;

FIG. 13 is a cross sectional view showing another aspect of a heating medium flow path which has a divided portions;

FIGS. 14A to 14C are views illustrating a heating medium flow path which has inner wall surfaces with wave profile;

FIGS. 15A and 15B are views illustrating an entire structure of a concentric flow type of fluidic device according to the present invention;

FIG. 16 is a view illustrating a heating medium flow path which has a tapered structure; and

FIG. 17 is a view illustrating heating medium flow path which has an inner circumferential surface with wave profile.

### DETAILED DESCRIPTION OF THE PREFERRED EMBODIMENTS

Now, preferred embodiments of a fluidic device according to the present invention will be explained in detail below with reference to the accompanying drawings.

(First Embodiment)

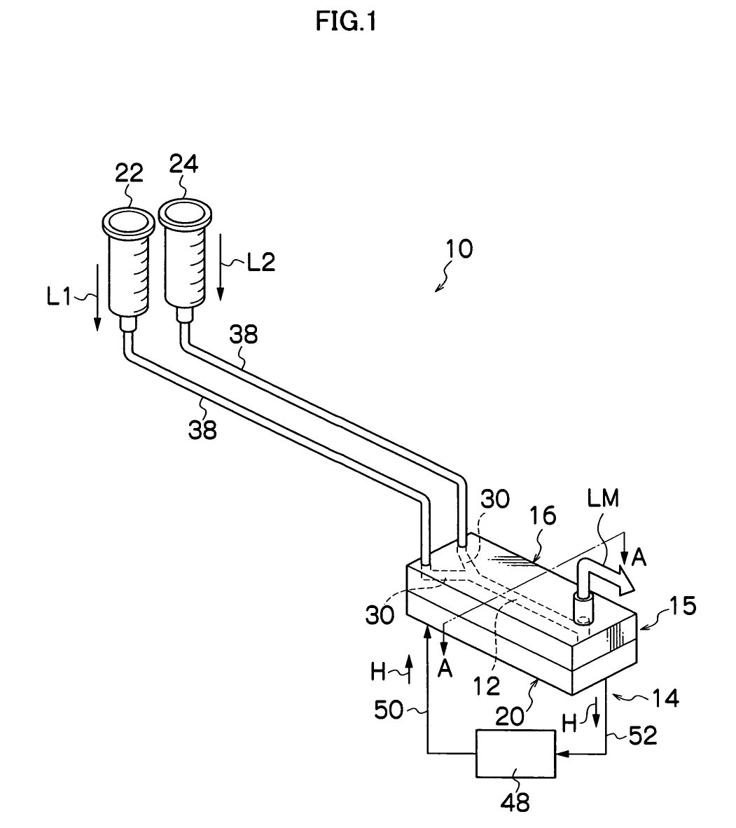

FIG. 1 is a view illustrating an entire structure of a first embodiment of a fluidic device according to the present invention, and shows a thin film flow type of fluidic device 10 which forms a thin film flow type of laminar flows. In the following explanation, a micro flow path having a flow path width of 1 mm or less is used as a fluid flow path, and two kinds of liquids L1 and L2 for liquid-liquid reaction are used as fluids.

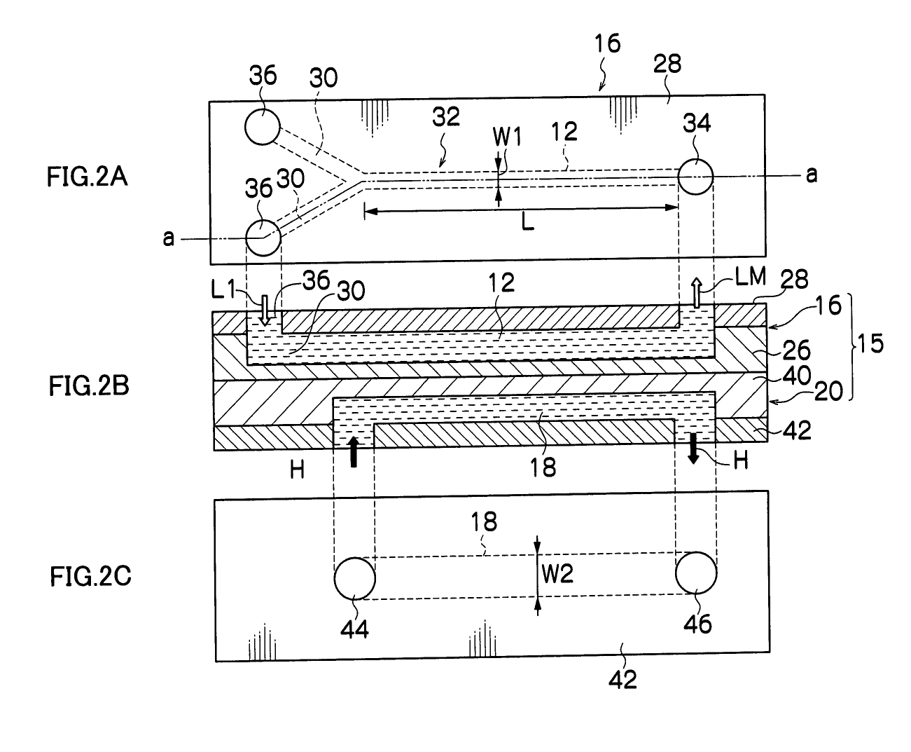

As shown in FIG. 1, the thin film flow type of fluidic device 10 generally includes, a tabular fluid flow path plate 16 having a fluid flow path 12 formed therein, a heating medium flow path plate 20 which is mounted to a lower surface of a fluid flow path plate 16 and having a heating medium flow path 18 formed therein (see FIG. 2), a first fluid supplying device 22 for supplying the liquid L1 to the fluid flow path 12, a second fluid supplying device 24 for supplying the liquid L2 to the fluid flow path 12, and a temperature regulating mechanism 14 for regulating a temperature of the liquids L1 and L2 in the fluid flow path 12. Hereinafter, a combination of the fluid flow path plate 16 and the heating medium flow path plate 20 is referred to as a device body 15.

FIGS. 2A to 2C are views illustrating a device body of a fluidic device: FIG. 2A is a top view of the same; FIG. 2B is a cross sectional view of the same, taken along the A-A line of FIG. 2A; and FIG. 2C is a bottom view of the same.

As shown in FIG. 2, the device body 15 includes the fluid flow path plate 16 and the heating medium flow path plate 20. The fluid flow path plate 16 includes a body member 26 and a cover member 28, and the body member 26 has the fluid flow path 12 in which a liquid-liquid reaction of two liquids L1 and L2 takes place, and a Y shaped fluid flow path 32 which is consisted of two fluid supplying paths 30 for the two liquids L1 and L2 respectively to make the liquids L1 and L2 merge into the fluid flow path 12. At a terminal end of the fluid flow path 12, a liquid exhaust port 34 is formed for exhausting a reaction product liquid LM produced by a liquid-liquid reaction. To the contrary, in the cover member 28, two fluid introduction ports 36 are formed for introducing the liquids L1 and L2 into the two fluid supplying paths 30, and are connected via two fluid supply tubes 38 (see FIG. 1) to a pair of fluid supplying devices 22, 24 for supplying the liquids L1 and L2 to the two fluid introduction ports 36.

The fluid flow path 12 is preferably a narrow flow path in a form of micro channel having a flow path width of 1 mm (1000 μm) or less, preferably 500 μm or less, and a flow path depth of 1 mm or less, preferably 500 μm or less. The fluid flow path 12 generally has a rectangular cross section in a radial direction thereof, but is not limited to have a rectangular cross section. When two fluid supplying paths 30 are provided, each fluid supplying path 30 is preferably designed to have a flow path width which is half that of the fluid flow path 12. For example, when a fluid flow path of a rectangular cross section in a radial direction thereof is provided to have a width of 500 μm and a depth of 200 μm, one fluid supplying path is designed to have a width of 250 μm and a depth of 200 μm. Also, the fluid flow path is designed to have a length L (see FIG. 2) which is enough to complete a liquid-liquid reaction and varies depending on a type of the liquid-liquid reaction.

The heating medium flow path plate 20 includes a body member 40 and a bottom member 42, and the body member 40 has the heating medium flow path 18 formed therein through which a heating medium H flows at a desired temperature. In FIG. 2, the heating medium flow path 18 is a linear flow path having a length which is equal to that of the fluid flow path 12, but the heating medium flow path 18 may be a Y-shaped heating medium flow path, similar to the fluid flow path 12, which has an extended portions to follow the two fluid supplying paths 30. The bottom member 42 has a heating medium supply port 44 for supplying the heating medium H to the heating medium flow path 18 and a heating medium exhaust port 46 for exhausting the heating medium H, so that, to the heating medium supply port 44, a outward pipe 50 of a heating medium supplying device 48 (see FIG. 1) for circulating the heating medium H at a desired temperature is coupled, and a homeward pipe 52 is coupled to the heating medium exhaust port 46 of the device 48 (see FIG. 1). This forms the temperature regulating mechanism 14 which regulates a reaction temperature of the fluids L1 and L2 in the fluid flow path 12. The temperature regulating mechanism 14 of the present invention circulates the heating medium H at a desired temperature to the formed heating medium flow path 18 along the flow direction of the liquids L1 and L2 in the fluid flow path 12, and has a disturbance producing device 13 for producing turbulence in the flow of the heating medium H.

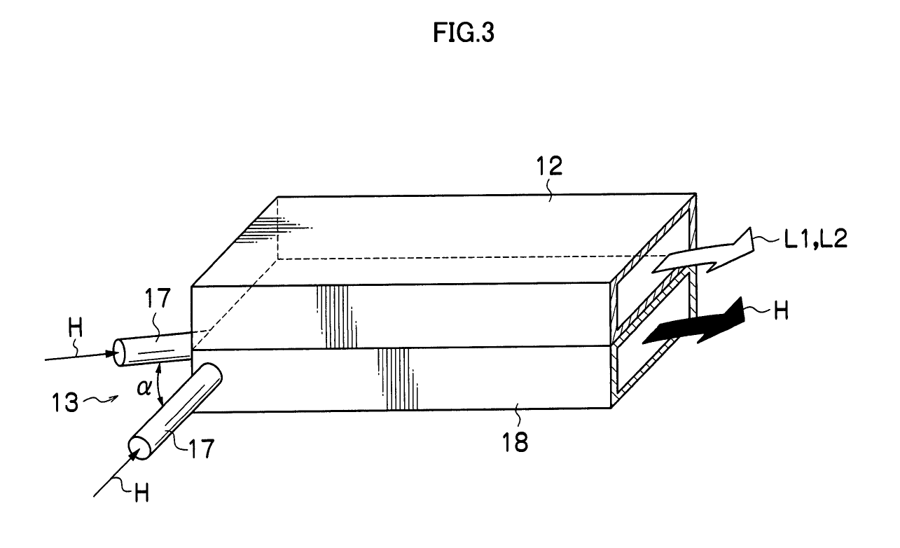

FIG. 3 is a conceptual view showing the disturbance producing device 13 in a form of a plurality of heating medium supply tubes 17 which supply a heating medium H into the heating medium flow path 18 and make the flows of the heating medium H collide to each other. As shown in FIG. 3, two heating medium supply tubes 17 are arranged at a generally right angle α at the entrance of the heating medium flow path 18 so that the two heating medium flows collide to each other in flowing into the heating medium flow path 18. This produces turbulence such as a vortex flow in the flow of the heating medium H in the heating medium flow path 18. The vortex flow breaks a laminar film which is formed near a flow path wall in the heating medium flow path 18, and makes the film thinner, thereby a rate of heat transfer from the heating medium flow path 18 to the fluid flow path 12 can be improved. The number of the heating medium supply tubes 17 is not limited to two, and three or more heating medium supply tubes 17 may be provided. Also, the angle at which the plurality of heating medium supply tubes 17 are arranged may be conveniently chosen so that a vertex flow can be readily produced in the heating medium by collision of heating medium flows.

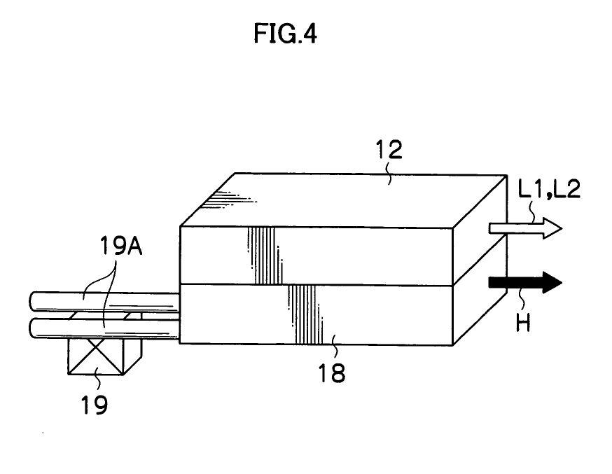

FIG. 4 is a conceptual view showing the disturbance producing device 13 in a form of a low frequency vibration applying device 19 for applying low frequency vibrations to the heating medium H in the heating medium flow path 18. As shown in FIG. 4, the low frequency vibration applying device 19 is provided in the heating medium flow path 18 with being in contact with two pipes 19A (or one pipe 19A) which supply the heating medium H, so that a low frequency is applied to the heating medium H which is supplied to the heating medium flow path 18. This produces turbulence such as a vortex flow in the laminar flow of the heating medium H in the heating medium flow path 18. The vortex flow breaks a laminar film which is formed near a flow path wall in the heating medium flow path 18, and makes the film thinner, thereby a rate of heat transfer from the heating medium flow path to the fluid flow path can be improved. The frequency of a low frequency vibration is preferably within a range of 30 to 300 Hz.

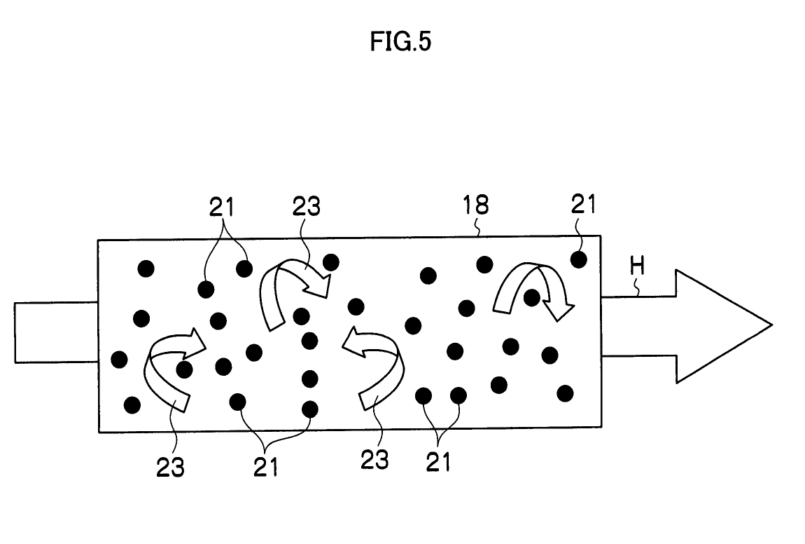

FIG. 5 is a conceptual view showing the disturbance producing device 13 in a form of a number of fine particles 21 (or air fine bubbles 21) to be mixed in the heating medium H. The fine particles 21 (or air fine bubbles 21) mixed in the heating medium cause turbulence such as a vortex flow 23 in the flow of the heating medium H. The vortex flow 23 breaks a laminar film, and makes the film thinner. Also, the fine particles 21 (or air fine bubbles 21) mixed in the heating medium rub the flow path wall in the heating medium flow path 18, resulting in breaking the laminar film. A cross sectional area of the fine particles 21 (or air fine bubbles 21) is preferably one tenth that of the heating medium flow path 18 or less.

The above described disturbance producing devices 13 may be individually used, or may be used in combination of two or more of them. In addition, the above described disturbance producing devices 13 may be combined with a structure of the heating medium flow path 18 which will be explained below so as to further improve a rate of heat transfer from heating medium flow path 18 to the fluid flow path 12.

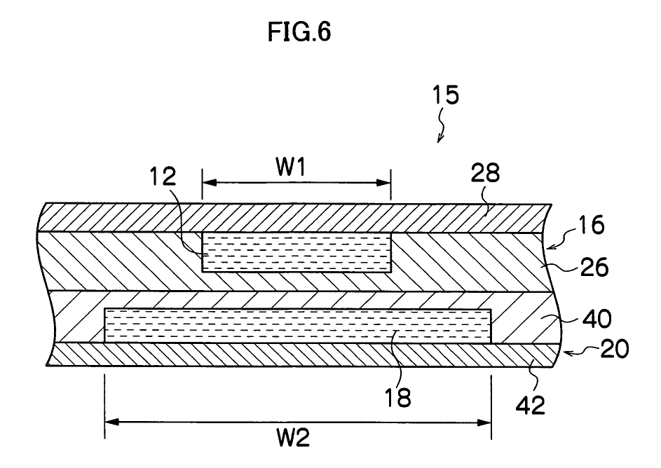

FIG. 6 is a view showing a structure of the heating medium flow path 18, and in a cross sectional view taken along A-A line in FIG. 1. FIG. 6 is also a view showing a flow rate distribution at a center portion and both end portions (wall surface portions in the direction of the flow path width where a laminar film is formed) of the heating medium flow path 18 in the direction of the flow path width.

As shown in FIG. 6, a flow path width W2 of the heating medium flow path 18 is formed wider than a flow path width W1 of the fluid flow path 12. Even when a thick laminar film is formed due to the laminar flow of the heating medium in the heating medium flow path 18, this wider flow path width W2 of the heating medium flow path than the flow path width W1 of the fluid flow path 12 makes the laminar film shifted in a direction toward outside of the flow path width W1 of the fluid flow path 12. So when the positions of the laminar film formed in the heating medium flow path 18 are seen in a relative relationship to the position of the fluid flow path 12, the laminar films near the flow path wall become apparently thin, and further it is possible to eliminate the laminar films from the flow path width W1 of the fluid flow path 12. As a result, a rate of heat transfer from the heating medium flow path 18 to the fluid flow path 12 can be improved.

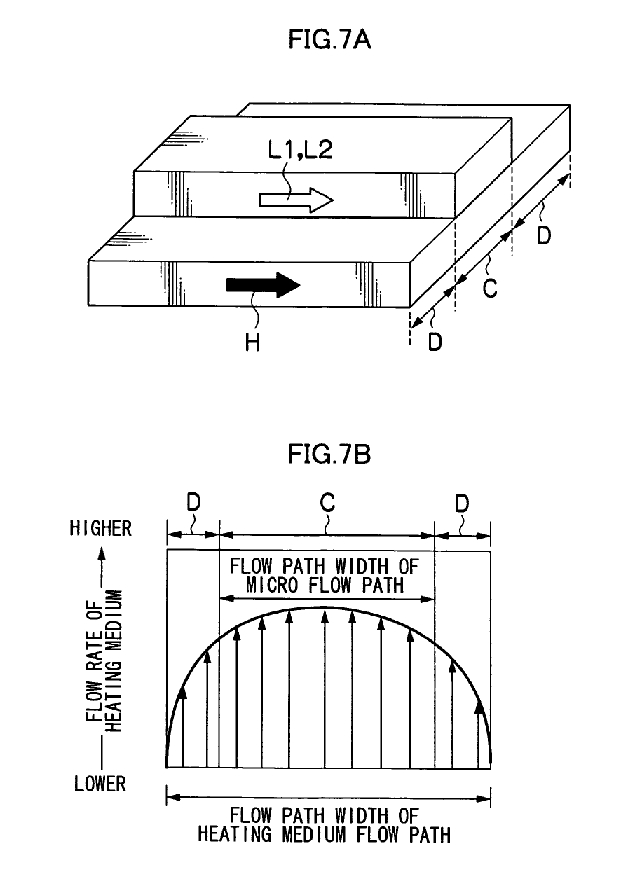

FIGS. 7A and 7B are conceptual views showing a distribution of a rate of heat transfer in the direction of flow path width of the heating medium flow path 18, by way of a flow rate distribution of the heating medium in the width direction. Assuming a white arrow of FIG. 7A shows the liquids L1 and L2 in the fluid flow path 12, and a black arrow shows the heating medium H in the heating medium flow path 18, as shown in the flow rate distribution of the heating medium H (a longer arrow shows a faster flow rate) in FIG. 7B, the flow rate of the heating medium H is higher at a portion C where the flows of the liquids L1 and L2 and the flow of the heating medium H are overwrapped, which indicates a higher rate of heat transfer. To the contrary, the flow rate is lower at portions D where the flows of the liquids L1 and L2 and the flow of the heating medium H are not overwrapped, which indicates a lower rate of heat transfer. So according to the temperature regulating mechanism 14 of the present invention, a temperature regulation of the liquids L1 and L2 in the fluid flow path 12 can be performed at the portion C where a flow rate of the heating medium H is high (high rate of heat transfer), thereby a rate of heat transfer to the liquids L1 and L2 in the fluid flow path 12 is increased, and a responsiveness to temperature control can be improved.

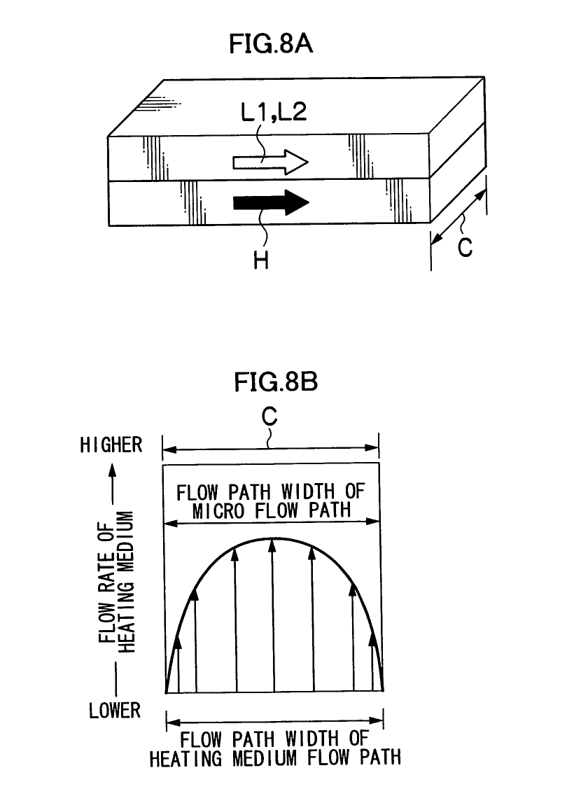

FIGS. 8A and 8B are conceptual views showing a distribution of a rate of heat transfer in the direction of flow path width of the heating medium flow path 18, by way of a flow rate distribution of the heating medium H in the width direction in the case where the flow path width W2 of the heating medium flow path 18 is equal to the flow path width W1 of the fluid flow path 12. Assuming a white arrow of FIG. 8A shows the liquids L1 and L2 in the fluid flow path 12, and a black arrow shows the heating medium H in the heating medium flow path 18, as shown in the flow rate distribution of the heating medium H in FIG. 8B, at a portion C where the flows of the liquids L1 and L2 and the flow of the heating medium H are overwrapped, a flow rate of the heating medium H is high at the central portion in the direction of the flow path width, but low at both ends, which shows a low rate of heat transfer. That is, in FIGS. 8A and 8B, a laminar film formed in the heating medium flow path 18 greatly influences and lowers the rate of heat transfer, and also produces a temperature distribution in the direction of the flow path width of the fluid flow path 12.

A preferable difference between the flow path width W1 of the fluid flow path 12 and the flow path width W2 of the heating medium flow path 18 was found by examining a flow rate distribution in the direction of the flow path width of the heating medium flow path 18. In this case, however, it is difficult to obtain a flow rate distribution of the heating medium flow path 18, which is narrow like a micro channel, by experiments, the flow rate distribution was calculated by using a software for numerical flow analyses, “RFLOW”, (by RFLOW Co. Ltd.) in the present invention. The result indicated that when the fluid flow path 12 and the heating medium flow path 18 are formed to satisfy the following formula (1), where the flow path width of the fluid flow path 12 is W1, the flow path width of the heating medium flow path 18 is W2, and W2−W1 is ΔW, the flow rate of the heating medium of the heating medium flow path 18 which corresponds to the rate at the both end portions of the flow path width W1 of the fluid flow path 12 can be maintained at 80% or more of the rate at the central portion of the flow path width W1 of the fluid flow path 12.
0.5≦ΔW/W1≦2 (1)

For example, when the fluid flow path 12 has a flow path width W1 of 1 mm, the heating medium flow path 18 will have a flow path width W2 of 1.5 mm to 3 mm.

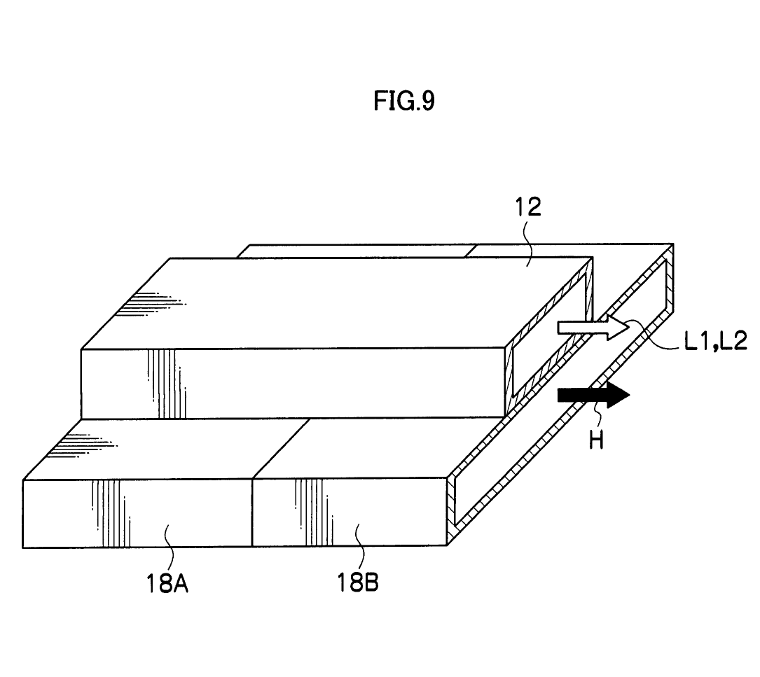

FIG. 9 is a view illustrating another aspect of the heating medium flow path 18, and a plurality of heating medium flow paths 18A and 18B are provided from upstream to downstream in a flow direction of the liquids L1 and L2 in the fluid flow path 12, to each of which a heating medium H at a different temperature is supplied. The configuration of the plurality of heating medium flow paths 18A, 1 8B from upstream to downstream in a flow direction of the liquids L1 and L2 in the fluid flow path 12 enables a supply of a heating medium H at a temperature which promotes reactions to the heating medium flow path 18A upstream of the fluid flow path 12, and a supply of heating medium H at a temperature which stops the reactions to the heating medium flow path 18B downstream of the fluid flow path 12. In FIG. 9, there are provided two heating medium flow paths 18A and 18B, but three or more heating medium flow paths may be provided.

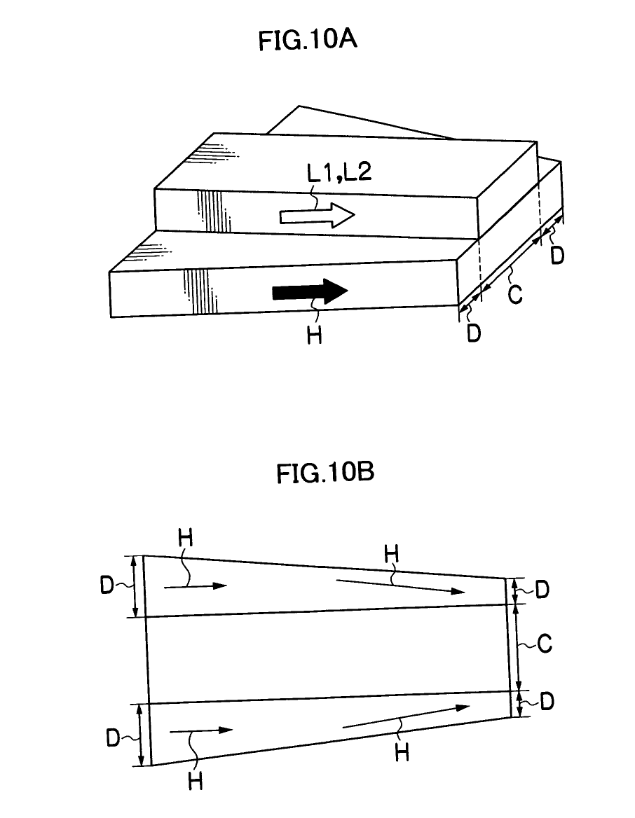

FIGS. 10A and 10B are views illustrating another aspect of the heating medium flow path 18, and the heating medium flow path 18 has a flow path width W2 which is tapered toward downstream of the corresponding fluid flow path 12. This causes, as shown in FIG. 10B, the flow rate of the heating medium H to be increased downstream (a longer arrow shows a higher flow rate) where the difference between the temperature of the heating medium H and the temperature of the liquids L1 and L2 gets smaller. As a result, a rate of heat transfer over the entire flow field of the fluid flow path 12 from upstream to downstream can be uniformed. When the above formula (1) is applied to the heating medium flow path 18 having this tapered configuration, the flow path width at the upstream end position, where the flow path width is the maximum, is preferably set to be W2, and the W2 and W1 are preferably set to satisfy W2>W1 at the downstream end position.

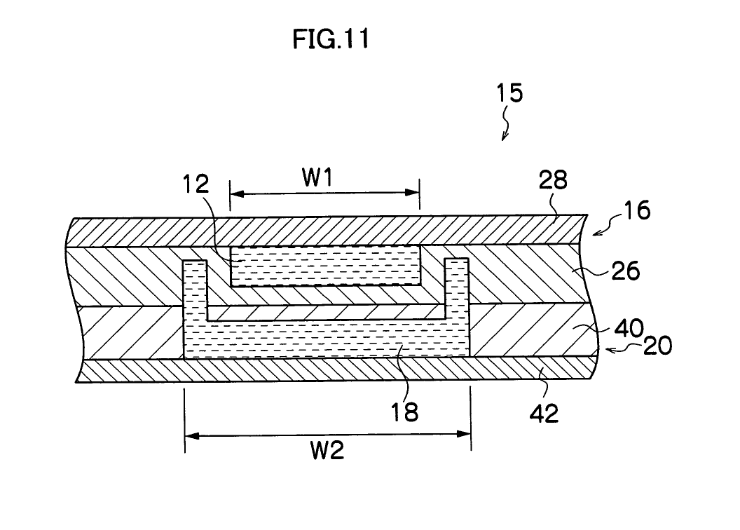

FIG. 11 is a view illustrating further another aspect of the heating medium flow path 18, and the heating medium flow path 18 is configured to have a concave cross section which surrounds the both ends and the bottom of the fluid flow path 12 in the flow path width direction. In this case, the flow path width W2 of the heating medium flow path 18 is defined to be the distance of the portion which is parallel to the bottom surface of the fluid flow path 12. The concave configuration allows the heat from the heating medium flow path 18 to be transferred to the sides of the fluid flow path 12, resulting in improving a rate of heat transfer at the both ends of the fluid flow path which tends to be low due to a laminar film.

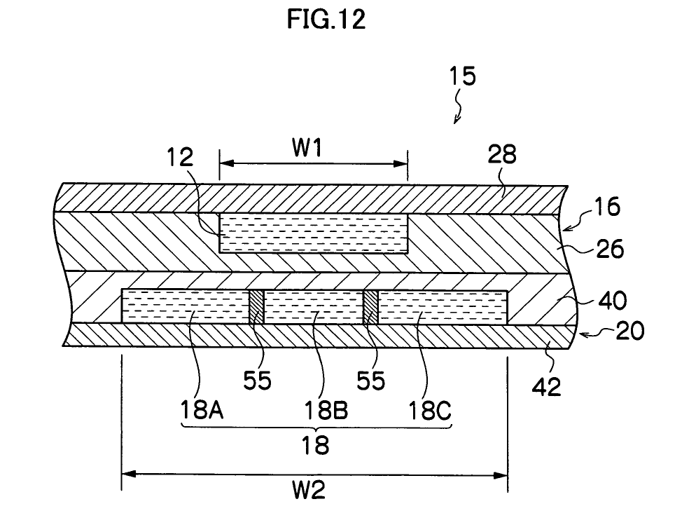

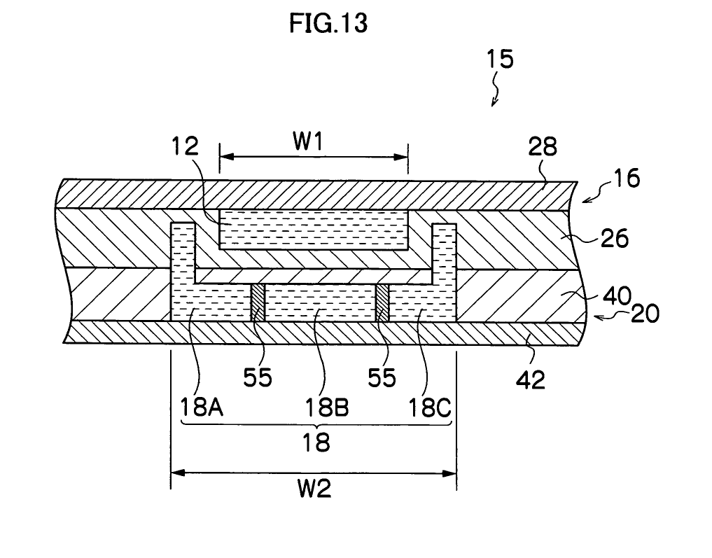

FIG. 12 and FIG. 13 are views illustrating further another aspect of the heating medium flow path 18, and the heating medium flow path 18 is divided into a plurality of divided flow paths 18A, 18B, and 18C, which are parallel to the flow direction of the liquids L1 and L2 in the fluid flow path 12, by using partition plates 55 so that a heating medium H at different temperatures and/or different flow rates can be individually supplied to the divided flow paths 18A, 18B, and 18C. FIG. 12 shows an example of the heating medium flow path 18 which has the configuration described for FIG. 6 and is divided into three portions, while FIG. 13 shows an example of the heating medium flow path 18 which has the configuration described for FIG. 11 and is divided into three portions. However, the number of divisions of the heating medium flow path 18 is not limited to three, and the heating medium flow path 18 may be divided into any number of portions as far as the number is two or more. The division of the heating medium flow path 18 into the divided flow paths 18A, 18B, and 18C allows a detailed control of the rate of heat transfer to avoid any distribution of the rate of heat transfer in the flow path width direction of the heating medium flow path 18, for example by setting the temperatures or the flow rates of heating mediums in the divided flow paths 18A and 18C on both sides to be higher than that of a heating medium in the middle divided flow path 18B.

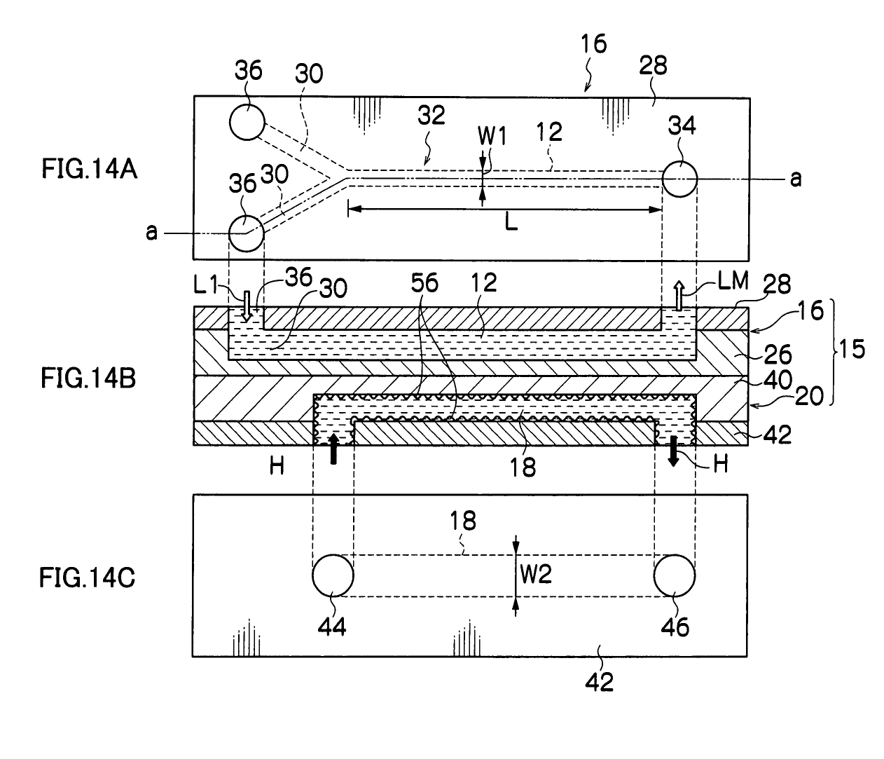

FIGS. 14A to 14C are views illustrating further another aspect of the heating medium flow path 18, and the heating medium flow path 18 is configured to have a wave profile 56. The wave profile 56 of the heating medium flow path 18 includes that the heating medium flow path 18 has an inner wall surface with a wave profile. The wave profile 56 produces a flow of the heating medium H in a vertical direction in the heating medium flow path 18, which breaks a laminar film, resulting in that the laminar film can be thinner compared to the case where the heating medium flow path 18 has a smooth inner wall surface. Especially when the fine particles 21 (or air fine bubbles 21) are used as the disturbance producing device 13, the irregular movements of the fine particles 21 (or air fine bubbles 21), after hitting the wave profile 56 of the inner wall surface in the heating medium flow path 18, more easily breaks a laminar film. When the air fine bubbles 21 hit the wave profile 56, the air fine bubbles 21 are readily broken up into further micro-sized bubbles, and also the energy generated in the breaking up can be expected to break a laminar film.

The device body 15 of the fluidic device 10 having such fluid flow path 12 and heating medium flow path 18 on the order of micrometers is manufactured by a method using a micro-processing technology, in which the body member 26 and the cover member 28 of the fluid flow path plate 16 are bonded to each other by covering the cover member 28 onto an upper surface of the body member 26, and the body member 40 and the cover member 42 of the heating medium flow path plate 20 are bonded to each other by covering the cover member 42 onto an upper surface of the body member 40. The micro-processing technology includes the following for example:
(1) LIGA Technology With X-ray lithography and Electroplating
(2) High Aspect Ratio Photolithography Using EPONSU8
(3) Mechanical Micro Cutting
(e.g. micro drilling by rotating a drill having a diameter on the order of micrometers at a high speed)
(4) High Aspect Ratio Processing of Silicon by Deep RIE
(5) Hot Emboss Processing
(6) Photo molding
(7) Laser Processing
(8) Ion Beam Etching

The device body 15 of the fluidic device 10 may be preferably manufactured with metal, glass, ceramics, plastic, silicon, polytetrafluoroethylene, and the like, depending on a need of heat resistance, pressure resistance, solvent resistance, processability, and the like. In manufacturing the device body 15, the manufacturing of fluid flow path 12 or heating medium flow path 18 is of course important, but a bonding technology for bonding the cover member 28 and bottom member 42 to the body members 26 and 40 respectively is important as well. The cover member 28 and the bottom member 42 are desirably bonded by an accurately bonding method which maintains dimensional accuracy without any breaking of the fluid flow path 12 or the heating medium flow path 18 due to degeneration or deformation of materials caused by a heating at a high temperature, and preferably a bonding in solid phase (for example, pressure welding and diffusion bonding) or in liquid phase (for example, welding, eutectic bonding, soldering, and adhering) is chosen to be used in consideration of manufacturing materials. For example, a silicon direct bonding for bonding silicon parts to each other when silicon is used for manufacturing, a fusion welding for bonding glass parts to each other, an anode bonding for bonding silicon and glass to each other, and a diffusion bonding for bonding metals to each other may be used. In bonding ceramics, a special bonding technology other than mechanical sealing technologies for metals is required, and for example a method may be used in which an adhesive called glass solder is printed on alumina in a thickness of 80 μm, and then is processed at 440 to 500 degrees C. without any pressure applied. Alternatively, new bonding technologies, although being still investigational, may be used which include a surface active bonding, a direct bonding which uses hydrogen bond, a bonding which uses an HF (hydrogen fluoride) solution.

The fluid supplying devices 22 and 24 in the fluidic device 10 of the present invention may be preferably syringe pumps of continuous flow system, and the heating medium supplying device 48 for circulating the heating medium H between the device body 15 and the device 48 may be preferably a micropump. In operating the fluidic device 10, a liquid controlling technology is required for introducing the liquids L1 and L2 and the heating medium H into the fluid flow path 12 and the heating medium flow path 18 respectively, and moreover, because the liquid behavior in the fine fluid flow path 12 and the heating medium flow path 18 on the order of micrometers has properties which are different from those in a macroscale, a fluid controlling system which is appropriate to a microscale needs to be applied. In the continuous flow system, the fluid flow path 12, the heating medium flow path 18, and other flow paths connected to the path 12 and path 18 are all filled with the liquids L1 and L2 or the heating medium H, which are all driven by the fluid supplying devices 22 and 24 and the heating medium supplying device 48 mounted outside, and supply pressures and supply amounts of the liquids L1 and L2 and the heating medium H to the fluid flow path 12 and the heating medium flow path 18 can be optionally controlled.

(Second Embodiment)

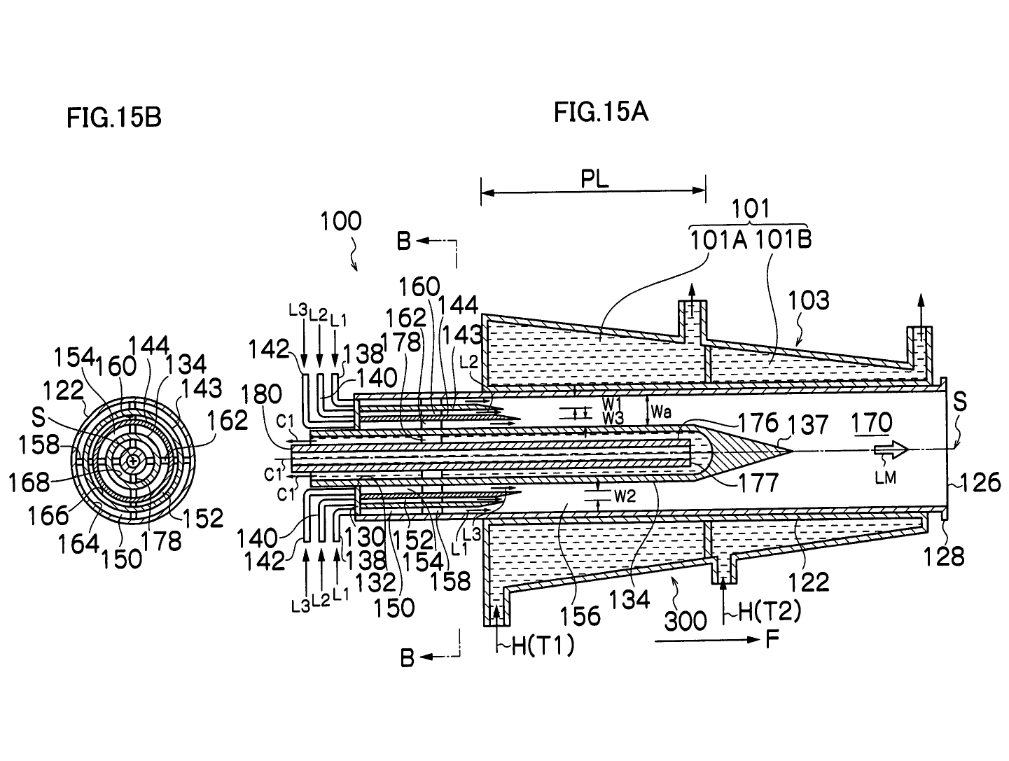

FIGS. 15A and 15B are views illustrating an entire structure of a second embodiment of a fluidic device according to the present invention which is a concentric flow type of fluidic device 100 for forming a concentric laminar flow. In the following explanation, three kinds of liquids L1, L2, and L3 for liquid-liquid reaction are used as fluids. A fluid flow path 111 which will be explained below in the second embodiment means a combination of a reaction flow path 156 and a liquid discharge path 170 for a reaction product liquid LM which is produced by a reaction, and the fluidic device 100 is configured to regulate a temperature of the liquids L1 and L2 in the reaction flow path 156 and the liquid discharge path 170 respectively by a temperature regulating mechanism 300.

The concentric flow type of fluidic device 100 is configured to generally include: a cylindrical fluid flow path block in which the fluid flow path 111 formed and the plurality of liquids L1, L2, and L3 are distributed therethrough as a concentric flow; a cylindrical heating medium flow path block which is mounted outside of the fluid flow path block and a heating medium flow path 101 is formed therein; a fluid supplying device for supplying the plurality of liquids L1, L2, and L3 to the fluid flow path 111; and a heating medium supplying device for supplying the heating medium to the heating medium flow path 101.

As shown in FIG. 15, the entire concentric flow type of fluidic device 100 is of a generally cylindrical shape, and has a cylindrical circular tube section 122 which forms a shell of the device. The straight line S in FIG. 15 designates a central axis of the device, and in the following explanation, an axial direction of the device means a direction along this central axis S. The circular tube section 122 has a tip end where a discharge opening 126 is formed for the reaction product liquid LM produced by reactions between the liquids L1, L2, and L3, and has a ring-shaped flange 128 which circumferentially extends from the discharge opening 126. The flange 128 will be connected to a pipe or the like for delivering the reaction product liquid LM to other fluidic devices or the like for subsequent processes.

The circular tube section 122 is closed at a base end thereof by a disc-like cover plate 130 which has a circular insertion hole 132 formed at the center thereof. A cylindrical rectifying member 134 is inserted into the circular tube section 122 from the base end of the circular tube section 122 to be coaxially disposed therein with the base end of the rectifying member 134 being inserted into the insertion hole 132 of the cover plate 130 to be fitted and supported there.

In the circular tube section 122, there are provided a cylindrical first separating member 143 and a second separating member 144 in a multi-tube structure for partitioning a space in the circular tube section 122 along the axial direction with base end surfaces of the first separating member 143 and the second separating member 144 being fixedly attached to the cover plate 130. The separating members 143 and 144 are coaxially disposed in the circular tube section 122 and the rectifying member 134 respectively, and partition the space of a circular annular cross section between the circular tube section 122 and the rectifying member 134 into three coaxially divided portions. The ratio to divide the space is determined depending on the ratio between supply amounts of the liquids L1, L2, and L3. In addition, a plurality of spacers 158 (four, in this embodiment) are radially interposed between the inner surface of the circular tube section 122 and the outer surface of the first separating member 143, and also a plurality of spacers 160 (four, in this embodiment) are radially interposed between the first separating member 143 and the second separating member 144. And also, a plurality of spacers 162 (four, in this embodiment) are radially interposed between the inner surface of the second separating member 144 and the outer surface of the rectifying member 134. These plural spacers 158, 160, and 162 are individually formed in a rectangular plate, and are supported in the circular tube section 122 with the front and back surfaces thereof being parallel to the direction in which the liquids L1, L2, and L3 are distributed in the circular tube section 122 (the direction of an arrow F). The spacers 158, 160, and 162 serve to fixedly couple the two separating members 143, 144 and the rectifying member 134 to the circular tube section 122 and to set dimensions of opening widths W1, W2, and W3 of the fluid supplying paths 150, 152, and 154 in a radial direction (a direction which crosses with the fluid flow direction at a right angle) (see FIG. 15A). This allows the two separating members 143, 144 and the rectifying member 134 to be fixedly coupled to the circular tube section 122 individually with a strength sufficient to prevent any displacement from predetermined positions or deformation due to influences of liquid pressures of the liquids L1, L2, and L3 or gravity, and allows the opening widths W1, W2, and W3 to maintain the preset dimensions with high reliability.

The spaces of circular annular cross sections partitioned by the first and second separating members 143 and 144 form, in the order from the outside, a first fluid supplying path 150, a second fluid supplying path 152, and a third fluid supplying path 154. The cover plate 130 at the base end of the circular tube section 122 has insertion holes formed therein with being in communication with each of the fluid supplying paths 150, 152, and 154, and to the insertion holes, fluid supply pipes 138, 140, and 142 are connected for supplying the liquids L1, L2, and L3 to the first to third fluid supplying paths 150, 152, and 154. This configuration enables the pressurized liquids L1, L2, and L3 to be supplied from three fluid sources (not shown) mounted upstream of the fluidic device 100 through the fluid supply pipes 138, 140, and 142 to the first to third fluid supplying paths 150, 152, and 154.

In the circular tube section 122, a space of a circular annular cross section is formed which is positioned downstream of the separating members 143, 144 and upstream of a conical portion 137 of the rectifying member 134 and is in communication with the fluid supplying paths 150, 152, and 154, and the space of a circular annular cross section functions as a reaction flow path 156 where the liquids L1, L2, and L3 individually supplied from the fluid supplying paths 150, 152, and 154 merge each other and react to each other.

As shown in FIG. 15B, each of the first fluid supplying path 150, the second fluid supplying path 152, and the third fluid supplying path 154 has a first fluid supply port 164, a second fluid supply port 166, and a third fluid supply port 168 respectively at a tip end thereof. The fluid supply ports 164, 166, 168 are open in a shape of a circular annular cross section along a circle about the center S, and are concentrically arranged each other. The opening widths W1, W2, and W3 define opening areas of the fluid supply ports 164, 166, and 168 respectively, and depending on the opening areas of the fluid supply ports 164, 166, and 168 and supply amounts of the liquids L1, L2, and L3, the initial flow rates of the liquids L1, L2, and L3 to be introduced into the reaction flow path 156 through the fluid supply ports 164, 166, and 168 are determined. The opening widths W1, W2, and W3 are for example set to make the flow rates of the liquids L1, L2, and L3 supplied to the reaction flow path 156 through the fluid supply ports 164, 166, and 168 equal to each other.

The space downstream of the reaction flow path 156 in the circular tube section 122 functions as the liquid discharge path 170 where the reaction product liquid LM produced by reactions between the liquids L1, L2, and L3 in the reaction flow path 156 flows toward the discharge opening 126. When the reaction product liquid LM is produced by reactions between the liquids L1, L2, and L3, the reactions between the liquids L1, L2, and L3 need to be completed at the outlet portion in the reaction flow path 156. Therefore, the reaction flow path 156 needs to be set to have a path length PL (see FIG. 15A) along the direction of distribution of the liquids L1, L2, and L3 which is enough to complete the reactions between the liquids L1, L2, and L3. The fluidic device 100 is supposed to be constantly filled with the liquids L1, L2, and L3 and reaction product liquids LM produced by reactions between the liquids L1, L2, and L3 without any air gap, all of which are being distributed toward the discharge opening 126.

Not specifically shown in the drawings, but in the case of this concentric flow type of fluidic device 100 also, the above described disturbance producing device 13 may be provided to produce a turbulence such as a vortex flow in a heating medium flow in the heating medium flow path 101 so that a rate of heat transfer can be improved. The fluidic device 100 includes the disturbance producing device 13 which may be in the form of a plurality of heating medium supply tube 17, the low frequency vibration applying device 19, the fine particles 21 (or air fine bubbles 21), or any combination of these. Further, the disturbance producing device 13 may be combined with the heating medium flow path 101 of a configuration which will be explained below to further improve a rate of heat transfer.

That is, as shown in FIG. 15A, a body section 103 is provided on the outer circumferential surface of the circular tube section 122, and the body section 103 includes the cylindrical heating medium flow path 101 in which a heating medium H having a relatively large heat capacity such as water or oil flows, and is connected to a heating medium supplying device (not shown). The heating medium H is supplied from the heating medium supplying device to the heating medium flow path 101 for controlling a reaction temperature between the liquids L1, L2, and L3 in the circular tube section 122, and is circulated back to the heating medium supplying device. Preferably the temperature of the heating medium H to be supplied to the heating medium flow path 101 is conveniently set depending on the reaction temperature, the types of the fluids L1, L2, and L3, or the like. There may be provided a plurality of heating medium flow paths 101 (two, in FIG. 15) from upstream to downstream along the flow direction of the liquids L1, L2, and L3 in the fluid flow path 111, and the heating medium H may flow in each of heating medium flow paths 101A and 101B at different temperatures T1 and T2. Thus, the configuration with the plurality of heating medium flow paths 101A and 101B from upstream to downstream along the flow direction of the liquids L1, L2, and L3 in the fluid flow path 111 enables a heating medium H at a temperature (T1) for promoting reactions to be supplied to the heating medium flow path 101A which is positioned corresponding to the reaction flow path 156 upstream of the fluid flow path 111, and a heating medium H at a temperature (T2) for stopping the reactions to be supplied to the heating medium flow path 101B which is positioned corresponding to the liquid discharge path 170 downstream of the fluid flow path 111.

The rectifying member 134 may have another flow path formed therein for distributing a heating medium C1 so that a temperature regulation is further performed inside of the reaction flow path 156. That is, the rectifying member 134 includes a thin shell section having a hollow section therein, and a heating medium supply tube 176 having a diameter smaller than an inner diameter of the rectifying member 134 is inserted into the hollow section of the rectifying member 134 from the base end of the rectifying member 134. The heating medium supply tube 176 is coaxially supported to the rectifying member 134 by a blocking plate (not shown) which blocks the opening of the rectifying member 134 at the base end thereof and a plurality of spacers 178. The heating medium supply tube 176 has a tip end opening 177 which is positioned close to the root of the conical section 137, and the tip end opening 177 has a tip surface defining a supply port 180 which is open for supplying the heating medium C1 into the rectifying member 134. In this way, the heating medium C1 at a desired temperature is supplied from the heating medium supplying device into the heating medium supply tube 176 through the supply port 180 for controlling a reaction temperature.

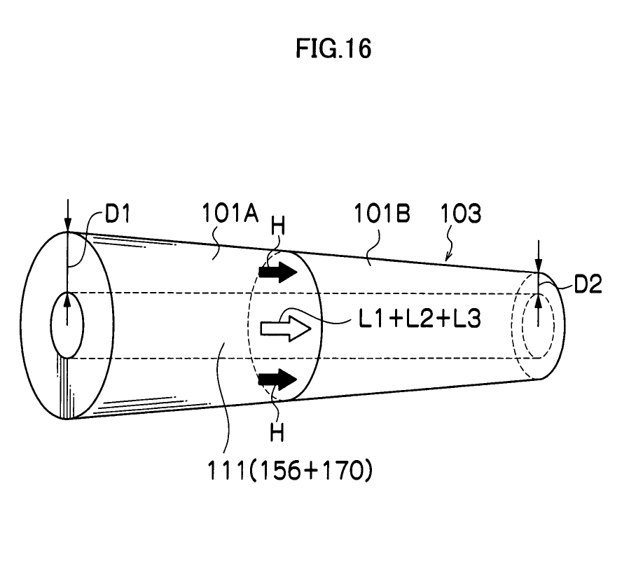

The cylindrical heating medium flow path 101 of the present invention, as shown in FIG. 15 and FIG. 16, is configured to have a tapered structure with a flow path radius D, where a flow path radius D1 upstream of the fluid flow path 111 is larger than a flow path radius D2 downstream. Due to this configuration, in the concentric flow type of fluidic device 100, as in the case of the thin film flow type of fluidic device 10, the flow rate of the heating medium H is increased downstream where the difference between a temperature of the heating medium H and a temperature of the liquids L1, L2, and L3 gets smaller. Therefore, a rate of heat transfer over the entire flow field of the fluid flow path 111 from upstream to downstream can be uniformed.

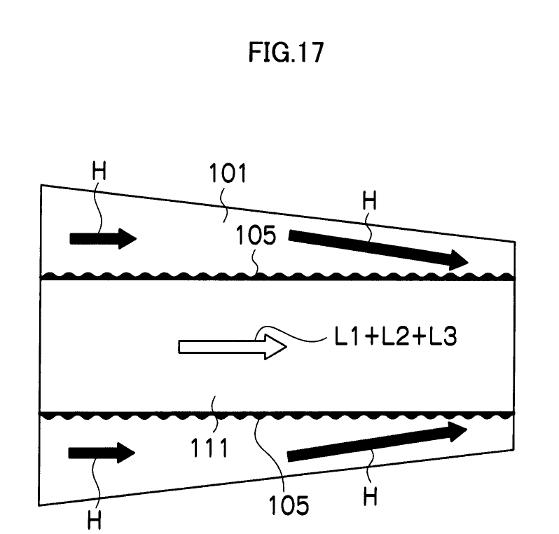

The concentric flow type of fluidic device 100 also preferably includes, as shown in FIG. 17, the cylindrical heating medium flow path 101 having a wave profile 105. The wave profile 105 of the heating medium flow path 101 includes that the heating medium flow path 101 has an inner wall surfaces with a wave profile, and for example preferably, among the inner wall surfaces (outer circumferential surface and inner circumferential surface), the inner circumferential surface which is closer to the fluid flow path 111 has the wave profile 105. The wave profile produces a flow of the heating medium H near the inner surface in a direction vertical to the fluid flow path which breaks a laminar film, resulting in that the laminar film can be thinner compared to the case where the heating medium flow path 101 has a smooth inner wall surface. As a result, turbulence can be produced without increasing a flow rate of the heating medium H, and a rate of heat transfer to the fluid flow path 111 can be improved, which also reduces energy consumption. The wave profile may be preferably a corrugated profile.

As for the concentric flow type of fluidic device 100, methods for manufacturing, materials to be used, devices for supplying fluids and heating medium, and the like are similar to those for the thin film flow type of fluidic device 10, and so will not be explained below.

### EXAMPLES

### Test 1 . . . Comparative Example

First, a test was conducted for a case in which a flow path width of a fluid flow path is equal to a flow path width of a heating medium flow path. That is, a fluid flow path plate which includes a fluid flow path formed therein, having a flow path width of 300 μm and a flow path depth of 200 μm, was constructed, and to a bottom surface of the fluid flow path plate, a heating medium flow path plate was mounted. The heating medium flow path plate includes a heating medium flow path formed therein having a flow path width of 300 μm, which is the same as that of the fluid flow path plate, and a flow path depth of 1000 μm. While a warm water at a temperature of 90 degrees C. was supplied to the fluid flow path, and a heating medium (coolant) at a temperature of 20 degrees C. below zero (−20degrees C.) was supplied to the heating medium flow path, the temperature of the warm water at the exit of the fluid flow path was measured by inserting a type K thermocouple having a diameter of 500 μm into the exit of the fluid flow path. The flow rate of the warm water through the fluid flow path was set to 1 mL/min, while the flow rate of the heating medium through the heating medium flow path was set to 5 mL/min.

As a result, the initial warm water temperature which had been of 90 degrees C. at the entrance of the fluid flow path was lowered to 53 degrees C. at the exit of the fluid flow path.

### Test 2 . . . Example 1 of the Present Invention

Next, a similar test was conducted by using a fluidic device of the present invention. That is, a heating medium flow path plate which was same as that in Test 1 was mounted to a bottom surface of a fluid flow path plate which was same as that in Test 1, and a low frequency vibration applying device was mounted to a bottom surface of the heating medium flow path plate as a disturbance producing device to apply low frequency vibrations to the heating medium in the heating medium flow path. The frequency of the low frequency vibrations was 90 Hz.

As a result, the low frequency vibrations applied to the heating medium in the heating medium flow path allowed the flow rate of the heating medium to be regularly increased up to about ten times that of the heating medium without the low frequency vibrations. This implies that a Reynolds number Re of the heating medium is also increased up to about ten times that of a laminar flow without the low frequency vibrations. And the temperature of the warm water which had been of 90 degrees C. at the entrance of the fluid flow path was lowered to 41 degrees C. at the exit of the fluid flow path.

What is claimed is:

1. A fluidic device, comprising:
a temperature regulating mechanism for regulating a temperature of a plurality of fluids in a reaction operation or a unit operation while the fluids are distributed in a fluid flow path,
wherein the temperature regulating mechanism includes a heating medium flow path formed therein along a flow direction of the fluids in the fluid flow path in which a heating medium at a desired temperature flows and a disturbance producing device for producing turbulence in a laminar flow of the heating medium.

2. The fluidic device according to claim 1, wherein the fluid flow path has a flow path width of 1 mm or less.

3. The fluidic device according to claim 1, wherein the disturbance producing device is a plurality of heating medium supply tubes which make heating medium flowing into the heating medium flow path collide to each other.

4. The fluidic device according to claim 2, wherein the disturbance producing device is a plurality of heating medium supply tubes which make heating medium flowing into the heating medium flow path collide to each other.

5. The fluidic device according to claim 1, wherein the disturbance producing device is a low frequency vibration applying device which generates low frequency vibrations in the heating medium.

6. The fluidic device according to claim 2, wherein the disturbance producing device is a low frequency vibration applying device which generates low frequency vibrations in the heating medium.

7. The fluidic device according to claim 1, wherein the disturbance producing device is fine particles to be mixed into the heating medium.

8. The fluidic device according to claim 2, wherein the disturbance producing device is fine particles to be mixed into the heating medium.

9. The fluidic device according to claim 7, wherein the fine particles have a cross sectional area which is one tenth that of the heating medium flow path or less.

10. The fluidic device according to claim 8, wherein the fine particles have a cross sectional area which is one tenth that of the heating medium flow path or less.

11. The fluidic device according to claim 1, wherein the disturbance producing device is air fine bubbles to be mixed into the heating medium.

12. The fluidic device according to claim 2, wherein the disturbance producing device is air fine bubbles to be mixed into the heating medium.

13. The fluidic device according to claim 11, wherein the air fine bubbles have a cross sectional area which is one tenth that of the heating medium flow path or less.

14. The fluidic device according to claim 12, wherein the air fine bubbles have a cross sectional area which is one tenth that of the heating medium flow path or less.

15. The fluidic device according to claim 1, further comprising:
a tabular fluid flow path plate having the fluid flow path formed therein for distributing the plurality of fluids;
a tabular heating medium flow path plate which is mounted to an upper surface or lower surface of the fluid flow path plate and has the heating medium flow path formed therein;
a fluid supplying device for supplying the plurality of fluids to the fluid flow path; and
a heating medium supplying device for supplying a heating medium to the heating medium flow path.

16. The fluidic device according to claim 2, further comprising:
a tabular fluid flow path plate having the fluid flow path formed therein for distributing the plurality of fluids;
a tabular heating medium flow path plate which is mounted to an upper surface or lower surface of the fluid flow path plate and has the heating medium flow path formed therein;
a fluid supplying device for supplying the plurality of fluids to the fluid flow path; and
a heating medium supplying device for supplying a heating medium to the heating medium flow path.

17. The fluidic device according to claim 1, further comprising:
a cylindrical fluid flow path block having the fluid flow path formed therein for distributing the plurality of fluids as a concentric flow;
a cylindrical heating medium flow path block which is mounted outside of the fluid flow path block and has the heating medium flow path formed therein;
a fluid supplying device for supplying the plurality of fluids to the fluid flow path; and
a heating medium supplying device for supplying a heating medium to the heating medium flow path.

18. The fluidic device according to claim 2, further comprising:
a cylindrical fluid flow path block having the fluid flow path formed therein for distributing the plurality of fluids as a concentric flow;
a cylindrical heating medium flow path block which is mounted outside of the fluid flow path block and has the heating medium flow path formed therein;
a fluid supplying device for supplying the plurality of fluids to the fluid flow path; and
a heating medium supplying device for supplying a heating medium to the heating medium flow path.
